(19) United States
(12) Patent Application Publication
(10) Pub. No.: US 2014/0337229 A1
(43) Pub. Date: Nov. 13, 2014

(54) ONLINE CHARGING SYSTEM

(71) Applicant: Benny Gustafsson, Lackeby (SE)

(72) Inventor: Benny Gustafsson, Lackeby (SE)

(73) Assignee: Telefonaktiebolaget L M Ericsson (pulb), Stockholm (SE)

(21) Appl. No.: 14/360,717

(22) PCT Filed: Nov. 28, 2011
(86) PCT No.: PCT/EP2011/071184

§ 371 Date: May 27, 2014

(51) Int. Cl. G06Q 30/04; G06Q 20/14; G06Q 20/22

(52) U.S. Cl. CPC G06Q 30/04; G06Q 20/22; G06Q 20/14
USPC 705/44; 705/39

(57) ABSTRACT

There is described an online charging system interacting with a telecommunication system for charging a service usage of an end-user and a related online charging method. In order to achieve a flexible rating logic it is suggested to execute a first rating session to determine a primary charge for a service according to a first rating logic and to execute a second rating session using at least part of session parameters from the first rating session to determine a secondary charge for the service according to a secondary rating logic. The secondary charge in stored in a secondary charging account which is associated with a primary charging account.

### TECHNICAL FIELD

The present invention relates to an online charging system interacting with a telecommunication system for charging a service usage of an end-user. Further, the present invention relates to a method of operating the online charging system.

### BACKGROUND

Generally, in an online charging system it is possible to rate a service invoked by an end-user, e.g., a call. Based on the rating result, money may be deducted from a user account or as alternative a bonus may be added to the user account.

Here, existing online charging systems rate and charge services such that the final costs correspond to a rating plan as defined by the operator of the telecommunication system. However, while this approach is appropriate for normal service charging it lacks flexibility. In particular, there is no support for any rating dialogues with the end-user which may be executed during or after end of service usage. Therefore with existing rating solutions the end user always has to approve rating conditions in blanco prior to service delivery.

### SUMMARY

In view of the above, the technical problem underlying the present invention is to provide an online charging solution with a more flexible rating logic.

According to a first aspect of the present invention this object is achieved by a method of operating an online charging system interacting with a telecommunication system and providing online charging in relation to service usage of an end-user. The method comprising the steps executing a first rating session to determine a primary charge for a service according to a first rating logic, executing a second rating session using at least part of session parameters from the first rating session to determine a secondary charge for the service according to a secondary rating logic, and storing the secondary charge in a secondary charging account being associated with a primary charging account.

According to a second aspect of the present invention this object is also achieved by an online charging system interacting with a telecommunication system and providing online charging in relation to service usage of an end-user. The online charging system comprises a primary rating unit adapted to execute a first rating session to determine a primary charge for a service according to a first rating logic, a secondary rating unit adapted to execute a second rating session using at least part of session parameters from the first rating session to determine a secondary charge for the service according to a secondary rating logic, and a secondary charging account adapted to store the secondary charge in a secondary charging account being associated with a primary charging account.

An advantage of the present invention is to achieve the flexibility and option for instant handling of secondary charges compared to offline scenarios where all secondary charges have to be approved in blanco beforehand.

### BRIEF DESCRIPTION OF DRAWING

In the following preferred embodiments of the present invention will be explained with respect to the drawing in which:

FIG. 1 shows a schematic diagram of an online charging system according to an embodiment of the present invention;

FIG. 2 shows a flowchart of operation for the online charging system shown in FIG. 1;

FIG. 3 shows a schematic diagram of an online charging system according to a further embodiment of the present invention;

FIG. 4 shows a flowchart of operation for the online charging system shown in FIG. 3;

FIG. 5 shows a flowchart of interoperation between the online charging system shown in FIG. 1 and mobile communication system network nodes being involved in an online charging process;

FIG. 6A shows a further flowchart of interoperation between the online charging system shown in FIG. 1 and mobile communication system network nodes being involved in an online RFC 4006 diameter charging process;

FIG. 6B shows a continuation of the flowchart shown in FIG. 6A; and

FIG. 6C shows a continuation of the flowchart shown in FIG. 6B.

### DETAILED DESCRIPTION

In the following preferred embodiments of online charging will be explained with reference to the drawing.

Generally, online charging is a mechanism that directly interacts, e.g., in real-time, with an account and controls or monitors charges for a service usage. Online charging covers rating as an act of determining the cost of a service usage. Online charging is accessed by service elements in real-time before a service is delivered to an end-user.

Further, online charging is a process of checking whether credit is available, credit-reservation, deduction of credit from the end-user account when service is completed and refunding of reserved credit that is not used.

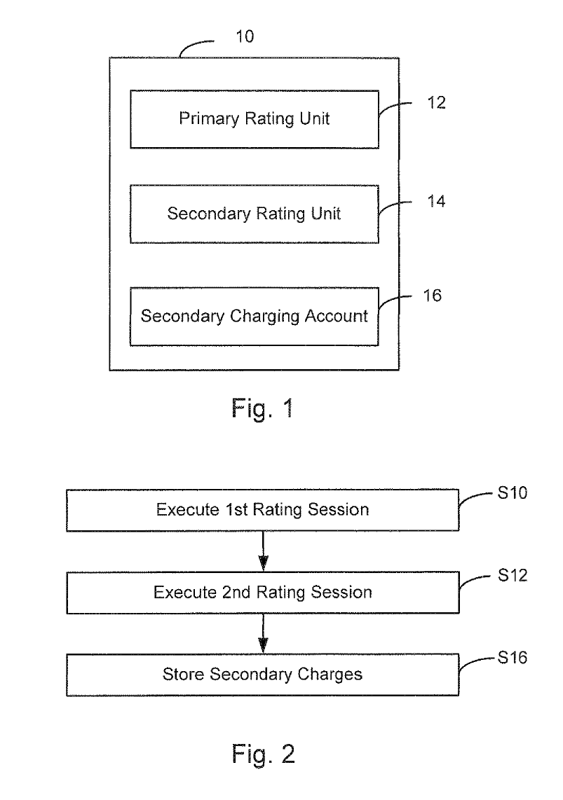

FIG. 1 shows a schematic diagram of an online charging system 10 according to an embodiment of the present invention.

The online charging system 10 shown in FIG. 1 executes a method of operating an online charging system interacting with a telecommunication system and providing online charging in relation to a service delivered to an end-user.

As shown in FIG. 1, the online charging system 10 comprises a primary rating unit 12, a secondary rating unit 14, and a secondary charging account 16.

FIG. 2 shows a flowchart of operation for the online charging system 10 shown in FIG. 1.

As shown in FIG. 2, in a step S10, operatively executed by the primary rating unit 12, there is executed a first rating session to determine a primary charge for a service according to a first rating logic. Here, e.g., the first rating logic may be pre-established by the operator of the telecommunication system.

As shown in FIG. 2, in a step S12, operatively executed by the secondary rating unit 14, there is executed a second rating session using at least part of session parameters from the first rating session to determine a secondary charge for the service according to a secondary rating logic. E.g., the second rating logic may reflect user authorization for service specific supplementary charges which are raised during service delivery, i.e. in real time.

Regarding the session parameters to be used for the first rating session and the second rating session these can be basically the same except that:
In the first rating session it is possible to consider intermediate calculations, i.e., a separate cost may be calculated as part of each interrogation to the online charging system 10.
In the second rating session the final call cost of the first rating session may be used as input parameter.
In the second rating session it would be possible to branch on conditions that are unique for the secondary charge.

Regarding the commonly used session parameters it should be understood that these session parameters are optional per rating session. In more detail session parameters may be based on one or more of the following examples:
Session parameters in relation to a traffic request, e.g., parameters that belong to the credit control request CCR command in RFC 4006, e.g., location,
Session parameters in relation to a subscriber, e.g., numbers of family members and friends.
Session parameters in relation to an account, wherein an account may be shared by several subscriber, e.g., counters, thresholds, balance, product offers.
Session parameters that belong to a user group, e.g., service class or community belonging.
Session parameters that are generic, e.g., date, day, time of the day.

Regarding the determination of the secondary charge such costs might, e.g., be determined to one or more of the following options:
As a certain percentage of the primary charges.
A remaining amount needed to round off the primary charge.
A bonus that has been gained by the end-user as part of the use of the delivered service.
A fixed fee, that might or might not be related to the primary charge.

As shown in FIG. 2, in a step S12, operatively executed by the secondary charging account 16, the secondary charge is stored in a secondary charging account 16 being associated with a primary charging account.

As a result of the first rating session a second rating activity is allowed to start as a chain reaction to the first rating session, e.g., in real time. The result of the secondary rating session is a cost in addition to the regular service-related costs of a service.

In particular, the secondary rating session can use the primary charge according to the first rating session as input parameter for the secondary rating session.

Then, the secondary rating session uses the secondary charging account as associated account in order to temporarily store the secondary charge. The secondary charge is a voluntary cost that will be deducted from the normal user service account upon end-user approval.

Generally, the deduction of the secondary charge may be executed after each interrogation to the online charging system 10 or after a final interrogation. In the latter case the amount of charges stored in the secondary charging account 16 should reflect the total of secondary charges generated during a charging session.

Overall, the introduction of the secondary charge allows to provide new types of online charging control and ratings. E.g., the secondary charges can be used in support of charity related services where the secondary rating session is invoked to calculate voluntary donations triggered through delivery of a regular service, e.g., a call. This allows to:
Increase the refill rate due to the deduction of secondary charges.
Increase the traffic in the telecommunication network, e.g., as the end-user feels that the cal is for a good cause.
Generate goodwill for the operator of the telecommunication network.
Raise money for charity organizations as many small donations might result in a big donation.
Make the subscriber feel satisfied by providing an easy way to make an instant donation in an affordable manner with respect to a small amount of money.

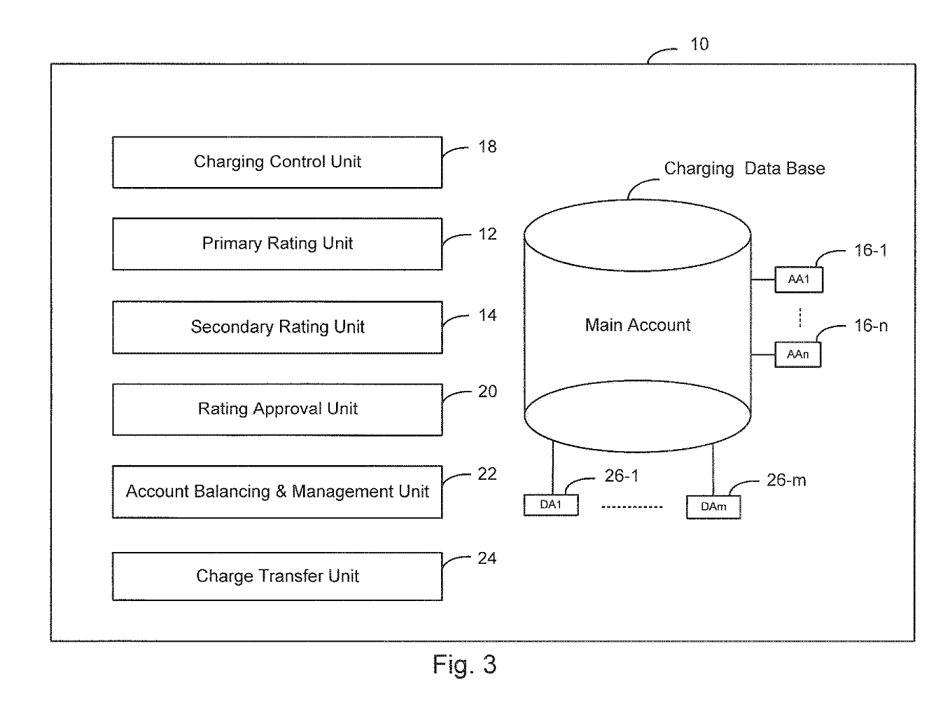

FIG. 3 shows a further detailed schematic diagram of an online charging system 10.

As shown in FIG. 3, in addition to the primary rating unit 12, the secondary rating unit 14, and the secondary charging account 16 shown in FIG. 1, the online charging system 10 may optionally comprise a charging control unit 18, a rating approval unit 20, an account management and balancing unit 22, and a charge transfer unit 24.

As shown in FIG. 3, the online charging system 10 may also comprise a charging data base realizing a main account, optional one or more dedicated accounts 26-1, . . . , 26-m, and at least one secondary charging account 16-1, . . . , 16n also referred to as associated account in the following.

It should be noted that the secondary charging account 16 or the associated accounts 16-1, . . . , 16-n may be implemented using, e.g., an isolated dedicated account 26-1, . . . , 26-m. The secondary charging account 16 may be adapted to keep a state logic, e.g., such as “currently in use” or “currently not in use”. The state “currently in use” applies if the secondary rating process is deducting money or is waiting for end-user approval such that the secondary charging account 16 is not available for other parallel rating sessions of the same user. This approach limits the number of secondary charging accounts 16-1, . . . , 16-n needed and at the same time provides a good solution form a usability perspective. In case of multi-users, i.e., the case of several subscribers sharing the same main account, it would be preferable to have one secondary charging account 16-1, . . . , 16-n per end-user.

Further, unlike a dedicated account that keeps money to cover for potential service costs, a secondary charging account 16 stores a calculated secondary charge that may be deducted later on upon end-user approval.

Still further, it may be assumed that the secondary charging account 16 may be implemented with a reservation logic. However, such a reservation logic is not essential. The reason for this is that the secondary charge is voluntary. Therefore, another option is to set a grace period for the secondary charges stored in the secondary charging account 16. Then, if an end-user does not respond back within this grace period or if there is no money left on the main account or the dedicate accounts 26-1, . . . , 26-m no secondary charge will be deducted. Further, once the grace period expires the secondary charging account 16 will be available for the next service delivery charging session.

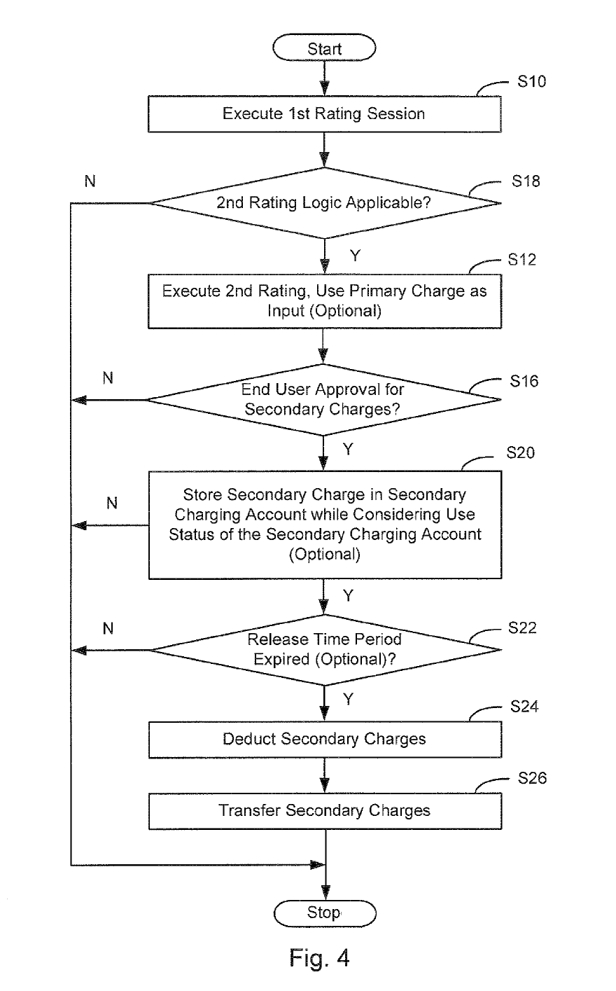

FIG. 4 shows a flowchart of operation for the online charging system shown in FIG. 3.

As shown in FIG. 4, in a step S10, operatively executed by the primary rating unit 12, there is executed the first rating session to determine a primary charge for a service invoked by an end-user according to a first rating logic.

As shown in FIG. 4, in a step s18, operatively executed by the charging control unit 18, there is decided on the application of the secondary rating logic to a service to be charged on the basis of at least one parameter selected from service data, service class data, and/or subscriber data.

Preferably, the step S18 of deciding on the application of the secondary rating logic to a service to be charged is executed on the basis of dynamic service data. Whether or not the secondary charges is to be used for a certain service scenario may preferably be decided by a combination of subscriber data and a set of branching conditions implemented, e.g., as a selection tree configuration.

In more detail, the charging control unit 18 shown in FIG. 3 may keep a number of parameters that are of special importance for real time charging where a secondary charge may be involved. Some of them reflect dynamic data that enable instantaneous decisions: during what instances to opt in the secondary charge, how to calculate the primary charge and when to send an end-user notification for a secondary charge. In the following there are given several examples for such parameters which may also be combined in their related usage:
Personal service offerings PSO bit: could be used the telecommunication system operator to indicate a temporary service or category of service users.
Offer identity: this might be related to a service campaign that is only valid during a limited period of time,
Service class value: a subscriber might temporarily belong to a certain service class, e.g., a gold membership, due to a value voucher refill.
Usage counter value: when a certain volume has been consumed a bonus might be obtained.
Date and time of day, end-users might be asked to donate money for service deliveries, e.g., calls, on a specific day, e.g., on Christmas Eve.
Account balance: here a secondary charge might only opt in if the account balance is above a certain limit.

The kind of information outlined above may be used instantly during a service delivery. This enables to tailor the usage of secondary charges from one service delivery to another. It also allows for some spontaneous micro-donations where each secondary charge will be presented individually to end-users for approval in real-time.

The flexibility and the option for instant handling of secondary charges offers an advantage compared to offline scenarios where all secondary charges have to be approved in blanco beforehand.

If the result of decision in step S18 is no the procedure shown in FIG. 4 ends while in the affirmative case the procedure shown in FIG. 4 proceeds to the next step.

As shown in FIG. 4, in the step S12, operatively executed by the secondary rating unit 14, there is executed the second rating session using at least part of the session parameters from the first rating session to determine a secondary charge for an invoked service according to the secondary rating logic. Preferably, the step S12 uses the primary charge session parameters as input parameters for the secondary rating session.

As shown in FIG. 4, in a step S16, operatively executed by the rating approval unit 20, there is achieved end-user approval for the secondary charge by executing a bidirectional exchange of approval data between the charging system 10 and the end-user or by executing a pre-defined approval setting through the end-user.

For voice and data calls the end-user approval procedure might be implemented either as a two way SMS dialogue in response to a secondary charge notification to the end-user or as a pre-defined approval setting that will be administered by the end-user, e.g., via interactive voice response IVR.

Another option could be to use a USSD dialogue or to report the applicable secondary charge to an external application that is responsible to confirm the actual end-user approval of secondary charges.

An example of the two-way dialogue could be: “Your cost was $1.80. If you would like to donate 20 cents for charity purposes then please press 1”. Then one or more charity organisations may benefit from this gift. Data warehouse reports in a post processing scenario or mobile money logic in a real time scenario may be used when transferring secondary charges to the one or more charity organisation(s).

If no user approval is given the procedure shown in FIG. 4 ends while in the affirmative case the procedure shown in FIG. 4 proceeds to a step S20.

As shown in FIG. 4, in the step S20, operatively executed by the secondary charging account 16 or equivalently the associated account 16-1, . . . , 16-n, there is executed the storing the secondary charge. Preferably, the secondary charging account 16 may be realized by using a dedicated charging account 26-1, . . . , 26-m of the online charging system in combination with a state logic reflecting a use status of the secondary charging account 16.

In other words, the online charging system 10 generally maintains a state of the first rating session and the second rating session as information that is related, e.g., to a reservation phase and being available at a subsequent deduction phase.

Further, state information could be some type of information that is not sent at each interrogation from the network so that the online charging system 10 has to store it itself.

Still further, state information may be derived through analysis of a delta in parameters values between succeeding interrogations.

Finally, state information is related resources that are granted and reserved until the usage is reported in the next interrogation, e.g., through counters and/or balances.

As shown in FIG. 4, in a step S22, operatively executed by the charging control unit 18, there is executed an interrogation whether a release time period set for the secondary charging account 16 has expired. Here, the secondary charging account is released for storage of new secondary charges upon expiry of the release time period.

If the release time period has expired the procedure shown in FIG. 4 ends while in the affirmative case the procedure shown in FIG. 4 proceeds to the next step.

As shown in FIG. 4, in a step S24, operatively executed by the secondary rating unit 14, there is executed a deduction of the secondary charges stored in the secondary charging account 16 from the related end-user account upon end-user approval.

As shown in FIG. 4, in a step S26, operatively executed by the charge transfer unit 24, there is executed a transfer of approved secondary charges to a receiving node in real time or after executing a post-processing of approved secondary charges.

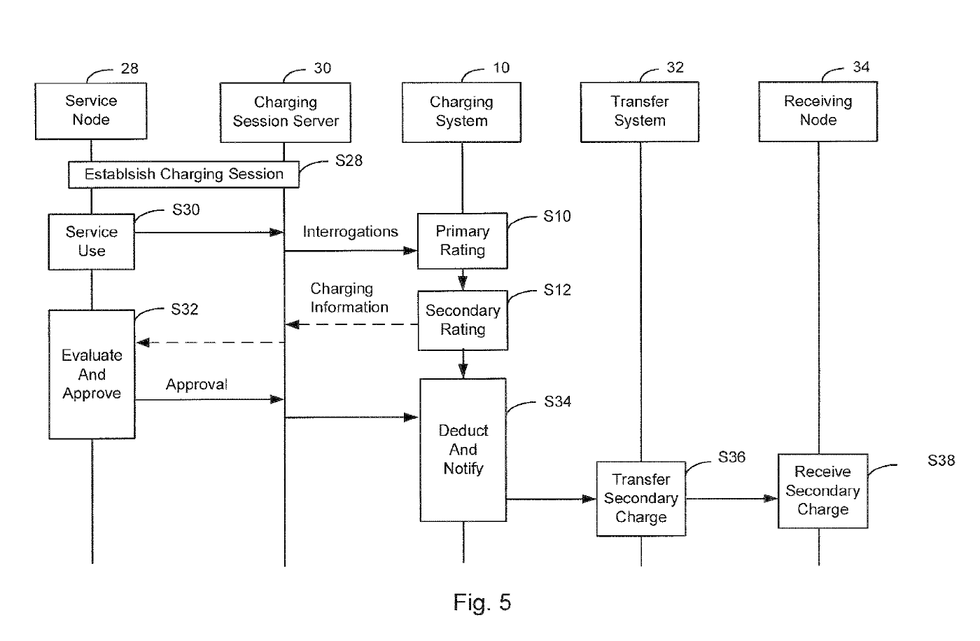

FIG. 5 shows a flowchart of interoperation between the online charging system 10 shown in FIG. 1 and mobile communication system network nodes being involved in an online charging process.

Further to the different structural elements explained so far with respect to FIG. 1 and FIG. 3, FIG. 5 shows a service node 28, a charging session server 30, a transfer system 32, and a receiving node 34.

As shown in FIG. 5, service node 28 interacts with the online charging system 10 through mediation of the charging session server 30. The service node 28 monitors the usage of assigned charging amounts according to instructions from the online charging system 10.

Further, the service node 28 may be a network element that provides a service to at least one end user, e.g., servers, proxies, a network access server, a SIP proxy, or an application server such as a messaging server, a content server, or a gaming server.

As shown in FIG. 5, a transfer system 32 is provided to transfer secondary charges determined in the online charging system 10 along the line outlined above to a receiving node 34. Here, the transfer system 32 has the same functionally as the charge transfer unit 24 explained above with respect to FIG. 3, however, is provided as separate entity outside the online charging system 10.

In the following the interoperation between the online charging system 10, the service node 28, the charging session server 30, the transfer system 32, and the receiving node 34 will explained with reference to FIG. 5.

As shown in FIG. 5, initially there is executed a step S28 to establish a charging session between the service node 28 and the charging session server 30. A session based charging control uses interrogations and the online charging system 10 maintains a session state for the session-based charging control. Possible interrogations are first to initiate a charging process, intermediate to request new quota while a service is being rendered, and/or final to exit the session-based charging control process. Further, the charging session may be established either from a core network or a service network.

In other words, a session based charging process uses an interrogation or equivalently a request/answer transaction to the online charging system 10 to initiate a session based charging process. During the charging process an interrogation is used to report the used quota and request a new one.

As shown in FIG. 5, after establishment of the charging session in step S28 the service node will execute service delivery in a step S30. Then, the service node 28 will forward interrogations through mediation of the charging session server 30 to the online charging system 10 so as to report used quota or request new ones. On the basis of the interrogations the online charging system 10 will then execute the first rating session in the step S10 to determine the primary charge for the service delivered by the service node 28 according to a first rating logic. As the primary charge is independent of the secondary charge it may be deducted immediately from the relevant account assigned in the charging data base.

As shown in FIG. 5, the online charging system 10 also executes the second rating session in a step S12 using at least part of session parameters from the first rating session to determine the secondary charge for the service according to the secondary rating logic. As the secondary charge is subject to approval by the end-user it is initially stored in the secondary charging account 16, as outlined above, and therefore is not immediately deducted.

As shown in FIG. 5, following the determination of the secondary charge the end-user will be notified of the primary charge and the secondary charge for evaluation and approval of the secondary charge in the step S32.

The notification of the end-user may be through, e.g., a network initiated SMS. It may include an A-subscriber MSISDN and a text to the end-user that describes the secondary charge as well as the option to approve it.

A first option to send the SMS is to send it via a SMS centre SMS-C.

As a second alternative option the SMS may be sent directly to an online mobile money centre, the second option improving performance and avoiding manipulation of the destination address. Here, the online mobile money centre will be a new origin of the SMS message to the end-user. It will deliver the message to the SMS centre SMS-C using the A-subscriber number MSISDN as the final destination address. Also, it might be that the online mobile money centre needs to include a fictive MSISDN as the origin address in case an end-user response to a network initiated SMS will not reach the online mobile money centre.

Further, irrespective of whether the online mobile money centre is involved or not the SMS centre SMS-C sends the message with charging-related information to the end user who approves the secondary charge by responding to a predefined option in the SMS text.

Then, the SMS is returned, e.g., to the online mobile money centre will analyse the SMS text for deduction of the secondary charge.

In addition to SMS there exist several alternative methods to perform the actual notification procedure. One would be to trigger a re-direct towards an URL where the end-user will be able to the secondary charge; this might be initiated over the charging session if supported by the applicable protocol. Another option would be to use a dedicated notification interface towards an external customer communication centre from where various types of end-user notifications may be supported, e.g., using software applets.

As shown in FIG. 5, after receipt of end-user approval at the charging system 10 the secondary charge will be deducted in step S34 from a charging account assigned to the end-user, e.g., in the main account or from a dedicated account 26-1, . . . , 26-m, subject that there is enough coverage for the secondary charge that is stored in the secondary charging account 16.

As shown in FIG. 5, step S34 is also executed to notify the transfer system 32 about the secondary charge for subsequent transfer to the receiving node 34.

Here, a first alternative would be that the transfer system 32, based on the provided secondary charging information, e.g., a charging detail record, creates a periodic report for each receiving node. This periodic report may then be used for further settlement.

A second alternative would be that the transfer system 32 is implemented in an online mobile money MM system and that the online charging system 10 reports to the online mobile money MM system the secondary charges and the determined receiving node. In such a case the online mobile money MM system needs to act as a trusted and secure network entity towards a mobile money MM system that realizes the final money transfer.

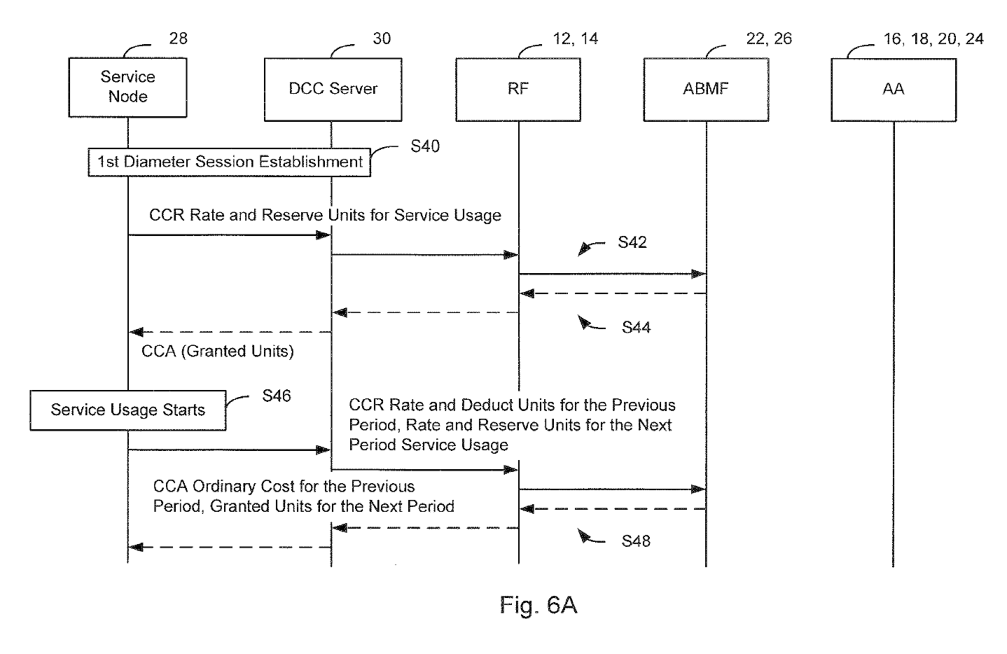

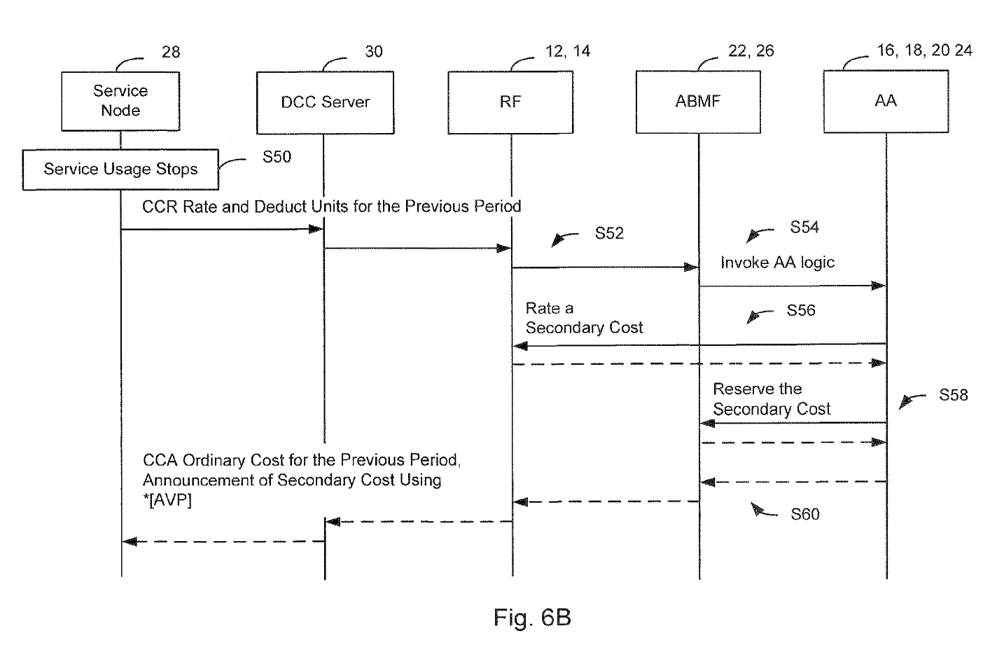

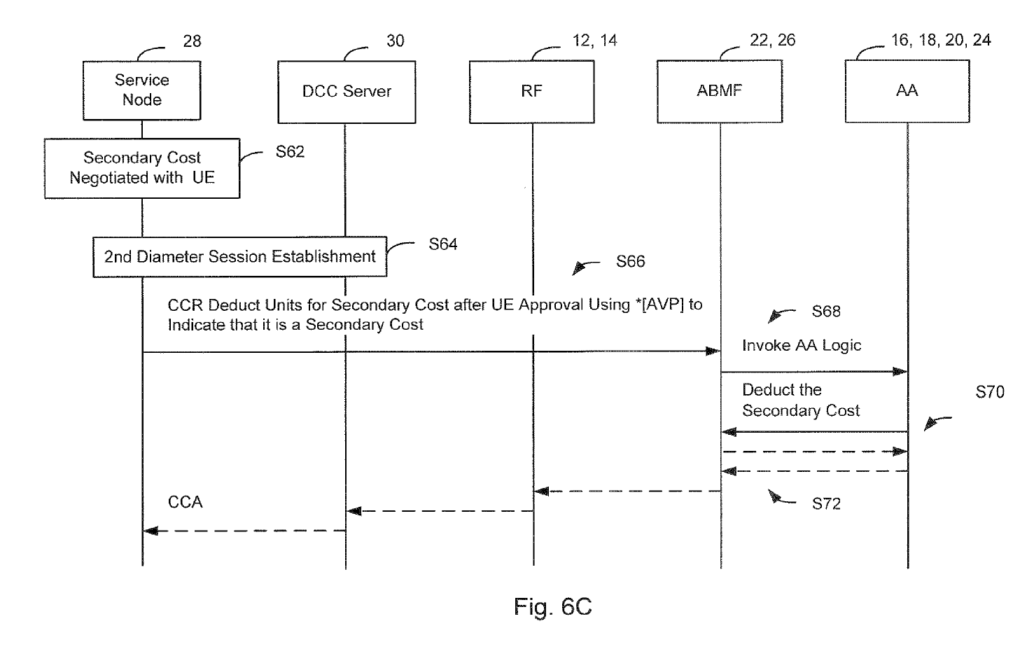

FIG. 6A to FIG. 6C show a further flowchart of interoperation between the online charging system 10 shown in FIG. 1 and mobile communication system network nodes being involved in an online RFC 4006 Diameter charging process.

In FIG. 6A to 6C reference is made to the service node 28 as equivalent to a service application provider, to a diameter credit control DCC server as an equivalent to the charging session server 30, to a rating function RF as an equivalent to the first rating unit 12 and the second rating unit 14, to an account balance management unit as an equivalent to the account balancing and management unit 22 and the dedicated account 26, and to the associated account logic AA as an equivalent to the secondary charging account 16, the charging control unit 18, the rating approval unit 20, and the charge transfer unit 24.

While in FIG. 6A to FIG. 6C the associated account logic AA is drawn up as a separate logical entity it could be well integrated into the Account Balance Management Function ABMF.

As shown in FIG. 6A, in a step S40 the end-user is connected to a data service, e.g., a web-portal, for which the service application provider would like to charge used units, i.e., volume, time or event. Heretofore, there is established a first diameter session.

As shown in FIG. 6A, in a step S42 the service application provider residing in the service node 28 acts as a diameter credit control DCC client and sends a credit control request CCR in order to rate and reserve units. The request terminates in the account balance management function ABMF. The rating function RF calculates the units to be granted for the next period and contacts the account balance management function ABMF in order to reserve the corresponding amount. Then, in a step S44 the granted units are returned to the service node 28 and the service usage is allowed to start in a step S46.

As shown in FIG. 6A, in a step S48 the service node 28 or in other words the service application provider reports used units and at the same time requests a new reservation of the next period. The rating function RF calculates the primary charges for the pervious period and contacts the account balance management function ABMF in order to deduct the corresponding amount. The rating function RF then calculates the units to be granted for the next period and contacts the account balance management function ABMF in order to reserve the corresponding amount. Then the cost and the granted units are both returned and service usage is allowed to proceed.

FIG. 6B shows a continuation of the flowchart shown in FIG. 3A.

As shown in FIG. 6B, in a step S50 service usage stops and in a step S52 the service node 28 and related service application provider report used units. The rating function calculates the primary charges for the previous period and contacts the account balance management function ABMF in order to deduct the corresponding amount. The total primary charge for the normal session is now known to the charging system.

As shown in FIG. 6B, in a step S54 an AA logic is invoked. The AA logic receives input parameters from the diameter credit control application DCCA access as well as the total primary charge from the normal session. Then, in a step S56 the rating function RF is contacted in order to calculate the secondary charge. In a step S58 the secondary charge is then reserved in the account balance management function ABMF.

As shown in FIG. 6B, in a step S60 the secondary charge is then included in a credit control answer CCA of the normal session using *[AVP] in the diameter credit control application DCCA. Then, the first diameter charging session established in step S40 shown in FIG. 6A is terminated.

FIG. 6C shows a continuation of the flowchart shown in FIG. 3B.

As shown in FIG. 6C, in a step S62 the service node 28 or in other words the service application provider is now aware of the secondary charges and starts a negotiation procedure with the end-user, e.g., by re-directing the end-user to a new web page where the secondary charge is announced, e.g., as a suggested voluntary donation.

As shown in FIG. 6C, in a step S64 a second diameter session is established. Then, the end-user may accept to donate the secondary charge, e.g., to a charity organization, by clicking a Yes-button. In a step S66 a diameter event is sent using *[AVP] on DCCA in order to indicate that the charge to be deducted is related to a secondary charge.

As shown in FIG. 6C, in a step S68 the AA logic is invoked. In a step S70 the AA logic invokes the account balance management function ABMF to deduct the secondary charge. At this moment the reservation that is kept from the first diameter session will be cleared.

As shown in FIG. 6C, finally in a step S72 the service node and related service application provider will be notified that the secondary charge has been deducted, and then the second diameter session will be terminated.

When used in a telecommunication system the AA logic enables real time charging scenarios. By combining a call related rating logic with a subsequent real-time analysis a secondary charge is calculated and stored on the associated account. The primary charge is used as a trigger for the secondary charge. This links two different charging scenarios which are both executed in real time. The first charging scenario is operator controlled and relates to mandatory service costs. The secondary charging scenario depends on end-user approval. Further, the primary charge and the secondary charge might result in separate revenue flows.

It should be noted that the secondary charging also relates to a computer program product directly loadable into the internal memory of a charging system comprising software code portions for performing the charging process when the product is run on a processor of the charging system.

Therefore, the secondary charging is also provided to achieve an implementation of the inventive method steps on computer or processor systems. In conclusion, such implementation leads to the provision of computer program products for use with a computer system or more specifically a processor comprised in e.g., an online charging system.

This programs defining the secondary charging functions can be delivered to a computer/processor in many forms, including, but not limited to information permanently stored on non-writable storage media, e.g., read only memory devices such as ROM or CD ROM discs readable by processors or computer I/O attachments; information stored on writable storage media, i.e. floppy discs and harddrives; or information convey to a computer/processor through communication media such as network and/or telephone networks via modems or other interface devices. It should be understood that such media, when carrying processor readable instructions implementing the secondary charging concept.

### ABBREVIATIONA

AA Associated Account

ABMF Account Balance Management Function

CCA Credit Control Answer

CCN Charging Control Node

CCR Credit Control Request

CDR Charging Detail Record

CN Core Network

CRS Charging Data Reporting System

DA Dedicated Account

DCC Diameter Credit Control

DCCA Diameter Credit Control Application

IVR Interactive Voice Response

MA Main Account

MM Multi Mediation

OCC Online Charging Control.

OCS Online Charging System

PSO Personal Service Offerings

Rc 3GPP Rc reference point

Re 3GPP Re reference point

RF Rating Function

RFC Request for Comments

SC Service Class

SCAP Service Charging Application Protocol

SDP Service Data Point

SMS Short Message Service

SMS-C SMS Centre

SN Service Network

UC Usage Counter

UE User Equipment

USSD Unstructured Supplementary Service Data

1. A method of operating an online charging system interacting with a telecommunication system and providing charging in relation to service usage of an end-user, the method comprising:
executing a first rating session to determine a primary charge for a service according to a first rating logic;
executing a second rating session using at least part of session parameters from the first rating session to determine a secondary charge for the service according to a secondary rating logic; and
storing the secondary charge in a secondary charging account being associated with a primary charging account.

2. The method according to claim 1, further comprising deciding on the application of the secondary rating logic to a service to be charged on the basis of at least one parameter selected from service data, service class data, and/or subscriber data.

3. The method according to claim 2, wherein the deciding on the application of the secondary rating logic to a service to be charged is executed on the basis of dynamic service data.

4. The method according to claim 1, further comprising using the primary charge according to the first rating session as input parameter for the secondary rating session.

5. The method according to claim 1, further comprising obtaining end-user approval for the secondary charge by executing a bidirectional exchange of approval data between the online charging system and the end-user or by executing a pre-defined approval setting through the end-user.

6. The method according to claim 1, further comprising providing the secondary charging account by using a dedicated charging account of the online charging system in combination with a state logic reflecting a use status of the secondary charging account.

7. The method according to claim 6, further comprising setting a release time period for the secondary charging amount stored in the secondary charging account, wherein the secondary charging account is released for storage of new secondary charges upon expiry of the release time period.

8. The method according to claim 6, further comprising deducting secondary charges stored in the secondary charging account from the related end-user account upon end-user approval.

9. The method according to claim 1, comprising transferring approved secondary charges to a receiving node in real time or after executing a post-processing of approved secondary charges.

10. An online charging system interacting with a telecommunication system and providing online charging in relation to service usage of an end-user, comprising:
a primary rating unit adapted to execute a first rating session to determine a primary charge for a service according to a first rating logic;
a secondary rating unit adapted to execute a second rating session using at least part of session parameters from the first rating session to determine a secondary charge for the service according to a secondary rating logic; and
a secondary charging unit adapted to store the secondary charge in a secondary charging account being associated with a primary charging account.

11. The online charging system according to claim 10, further comprising a charging control unit adapted to decide on the application of the secondary rating logic to a service to be charged on the basis of at least one parameter selected from service data, service class data, and/or subscriber data.

12. The online charging system according to claim 10, wherein the secondary charging unit is adapted to use the primary charge determined by the primary rating unit as input parameter for the secondary rating.

13. The online charging system according to claim 10, further comprising a rating approval unit adapted to achieve end-user approval for the secondary charge by executing a bidirectional exchange of approval data between the online charging system and the end-user or by executing a pre-defined approval setting through the end-user.

14. The online charging system according to claim 10, wherein the secondary charging account is implemented by a dedicated charging account of the online charging system in combination with a state logic reflecting a use status of the secondary charging account.

15. The online charging system according to claim 10, wherein the charging control unit is adapted to set a release time period for the secondary charging amount stored in the secondary charging account, wherein the secondary charging account is released for storage of new secondary charges upon expiry of the release time period.

16. The online charging system according to claim 10, wherein the charging control unit is adapted to deduct secondary charges stored in the secondary charging account from the related end-user account upon end-user approval.

17. The online charging system according to claim 10, further comprising a charge transfer unit adapted to transfer approved secondary charges to a receiving node in real time or after executing a post-processing of approved secondary charges.
